(19) United States
(12) Patent Application Publication
(10) Pub. No.: US 2021/0380180 A1
(43) Pub. Date: Dec. 9, 2021

(54) ELECTRIC SCOOTER

(71) Applicant: ESUS MOBILITY SL, Valencia (ES)

(72) Inventors: Juan Jose Garcia Henarejos, Valencia (ES); Francisco Santiago Soriano Romero, Barcelona (ES); William Molina Ventrium, Valencia (ES)

(21) Appl. No.: 17/245,900

(22) Filed: Apr. 30, 2021

(30) Foreign Application Priority Data
Apr. 30, 2020 (ES) P202030372

(51) Int. Cl. B62D 51/02; B62K 3/00; B62K 5/02

(52) U.S. Cl. CPC B62D 51/02; B62K 2202/00; B62K 5/02; B62K 3/002

(57) ABSTRACT

Electric scooter (1), with a foot rest area (2) and a loading area (3), made up of a chassis (4) with a handlebar (5) and two driving wheels (6) at a first end of the chassis (4), and comprising two electric motors connected to the driving wheels (6) with two controllers; steering control systems including an electronic sensor connected to a drive device and an electronic board connected to the electronic sensor and the two controllers, and; a support wheel (7) at a second end of the chassis, opposite the first end, having fastening points to the chassis (2) in the form of a pivot shaft (8) connected to the chassis and to a suspension fork (9).

### FIELD OF THE INVENTION

This invention falls within the technical scope of light vehicles, in particular to an electric scooter comprising a chassis with a handlebar and two driving wheels and, more specifically, to an electric scooter with a foot rest area for the user and an area with a high load capacity.

### BACKGROUND OF THE INVENTION

Nowadays, scooters have gone from being a toy for children to a widely used and demanded means of transport, mainly for inner-city transport, mainly after the emergence of electric scooters, which are equipped with a motor facilitating the scooter's mobility.

The surge in the use of scooters is due to several factors, including the growing and continuous flow of people through increasingly congested big cities, as well as people's heightened awareness of the need to act in an environmentally friendly way, which is driving the search for more efficient and cleaner means of transport.

All of this has led to a very significant number of people opting for this mode of transport in recent years, who rate it highly as a fast, efficient and sustainable way of getting around.

These users, however, face the drawback that this means of transport has a very low load capacity, limited to a rucksack that can be carried by the user and, in some new models, a somewhat higher capacity in containers attached to the scooter. This is still insufficient capacity for many users on a day-to-day basis.

Moreover, urban distribution of goods, known as the last mile, is a service that is becoming increasingly important for business logistics. Delivery drivers encounter major problems when carrying out their work since, in addition to having to deal with the heavy congestion that exists in cities, recently, due to the traffic restrictions that are increasingly being implemented in cities to try to reduce polluting emissions and damage to the environment, they have serious problems in carrying out their work.

Despite all these drawbacks, this type of last-mile transport continues to thrive, especially due to the rapid evolution of online commerce, which is becoming ever more popular among consumers and has led to a boom in home deliveries.

Logistics companies are trying to adapt by installing small urban freight platforms in city centres, designed to allow delivery drivers to make deliveries on foot, by bicycle, or in electric vehicles.

However, there are still some shortcomings, because even if in some cases delivery distances are reduced, they still need, as in all other cases, a means of transport that allows them to carry a certain weight and volume that does not require them to return to the head office after each delivery. This leaves no choice but to use vans and four-wheeled vehicles, despite their disadvantages in urban areas, as bicycles and electric vehicles such as scooters have no carrying capacity and require the delivery person to carry the load in a rucksack on their back.

In response to this problem, some lighter vehicles, such as scooters, are appearing recently, with improvements that already allow them to carry a certain weight and volume of cargo.

As an example of technical development, reference documents U52016/0339984 published on Nov. 24, 2016 to Li et al., CN205059655 published on Mar. 2, 2016 to Xiaming et al. and U52016/0144708 published on May 26, 2016 to Lee can be referred to.

Reference documents U52016/0339984 and CN205059655 relate to electric scooters which have some load capacity at the front, the former in a storage area and the latter by fitting a luggage compartment to the structure of the scooter.

Nevertheless, both models have a major disadvantage due to their lack of mobility. In the first case, with two front wheels and a rear wheel, and in the second case, which despite having only one wheel at the front, it is fixed and does not allow turning it, the driver will have a problem when changing direction, as it requires a wide space that is not easy to find in the middle of a city full of vehicles and pedestrians. Even when turning into a new street, the turning circle required is very large and the vehicle's manoeuvrability will be severely hampered in many cases.

Furthermore, in the first case, the load is positioned outside the front wheels, which can lead to instability.

Reference document U52016/0144708, on the other hand, is more oriented towards finding a folding luggage carrier solution that can operate as a scooter on occasions, but it does not have the features or the comfort of a scooter. And, although its single front wheel will allow greater mobility than in the previous cases, the rear wheels, fixed to the chassis, will mean that the mobility of the scooter will continue to be limited and tight for the real traffic conditions of a built-up area. In this case, the steering is determined by the turning of the front wheel, but both rear wheels, with the same rotational speed, will require a large radius to execute the change of direction set by the front wheel.

Therefore, it is necessary to find a solution that allows for means of freight transport and at the same time provides greater mobility, which is comfortable and efficient for the users.

### SUMMARY OF THE INVENTION

The electric scooter presented here includes a resting area for the user's feet and a loading area, and is made up of a chassis with a handlebar attached to it, and two driving wheels at the back edge of the chassis.

This electric scooter has two electric motors, each connected to one of the driving wheels and two controllers, each connected to one motor respectively.

Likewise, it has control mechanisms for turning the scooter, which consist, on the one hand, of an electronic control sensor connected to a user-operated device and, on the other hand, of an electronic board connected to said electronic control sensor and to the two motor controllers of the driving wheels to control their speed, so that a difference in speed between the driving wheels allows the scooter to turn.

In addition, this scooter includes a support wheel positioned at an opposite end of the chassis. This support wheel is attached to the chassis using a pivot axle with an upper end connected to the chassis and a lower end connected to a suspension fork attached to the axle of the support wheel. This type of fastening allows the support wheel to rotate freely, with the possibility of rotating 360° in any direction.

The electric scooter proposed here represents a significant improvement compared with the current technology.

The result is an electric scooter suitable for transporting loads and capable of addressing the mobility and product transport problems in the last mile in urban environments, practically and efficiently.

One of the biggest advantages offered by this electric scooter is its excellent manoeuvrability, as it has a turning mechanism designed so that the scooter can make 180° changes of direction practically on itself, with a very small turning circle that allows it to change direction without leaving the cycle lane where it is travelling.

This allows it to travel easily and freely along any road, making the turns it needs without putting either the load, the vehicles or pedestrians around it at risk.

The result is a scooter that not only benefits from being a sustainable means of transport, but also offers a simple and functional operation, as the steering system is controlled by an electronic board connected to an electric control sensor, making the scooter very easy to use.

The load area in the lower part of the chassis, in the space between the drive wheels and the support wheel, provides great stability and a high load capacity in a safe manner, and can comfortably transport up to 350 litres. It also offers load transport options depending on the volume and shape of the load, as it is possible to attach a containment element with an open upper end, box type, or a closed containment element, to transport loads with less stable shapes by themselves.

In this case, the user can put the entire load in the containment element and drive freely and comfortably, without the need to carry backpacks that serve as counterweights, as the scooter is completely balanced and stable.

In addition, this scooter has modern aesthetics and the visible parts of the scooter can be made of fibre and sheet metal, which enables a good balance between aesthetics, weight, cost and manufacturing time.

The bodywork is separate, which makes it much easier to maintain in case of breakage.

Therefore, it is a very efficient electric scooter for transporting people and loads in urban areas, as well as being very practical and manoeuvrable.

### BRIEF DESCRIPTION OF THE DRAWINGS

In order to provide a better understanding of this invention's characteristics, and according to a preferential example of its practical implementation, a series of illustrative and non-limiting drawings are provided forming an integral part of this description, in which the following is shown:

FIG. 1.—Shows a front perspective view of the scooter chassis, as a first preferred example of the invention.

FIG. 2.—Shows a front view of the scooter without load containment element, as a first preferred example of the invention.

FIG. 3.—Shows a dorsal view of the scooter without load containment element, as a first preferred example of the invention.

FIG. 4.—Shows a profile perspective view of the scooter without load containment element, as a first preferred example of the invention.

FIG. 5.—Shows a front view of the scooter with load containment element, as a first preferred example of the invention.

FIG. 6.—Shows a dorsal view of the scooter with load containment element, as a first preferred example of the invention.

FIG. 7.—Shows a profile perspective view of the scooter with load containment element, as a first preferred example of the invention.

FIG. 8.—Shows a front perspective view of the scooter with a load containment element open at its upper end, for a first preferred example of the invention.

FIG. 9.—Shows a front view of the scooter with a load containment element, for a second preferred example of the invention.

FIG. 10.—Shows a profile perspective view of the scooter with a load containment element, for a second preferred example of the invention.

### DETAILED DESCRIPTION OF THE INVENTION

In view of the figures provided, it can be seen how, in a first preferred version of the invention, the electric scooter (1) proposed here, includes a resting area (2) for the user's feet and a loading area (3), and is made up of a chassis (4) with a handlebar (5) fixed to it and two driving wheels (6) at one end of the chassis (4).

This scooter (1) includes two electric motors, each of which is connected to one of the driving wheels (6) and has two controllers each connected to one of these motors respectively.

Furthermore, the scooter (1) is equipped with a means of rotation control in the form of an electronic control sensor connected to a user-operated device and an electronic board connected to this electronic control sensor and to the two controllers of the motors of the driving wheels (6) for controlling the speed of the driving wheels (6).

As a result, through user control from the driving mechanism, it is able to control the electronic sensor, indicating the need to turn in one direction or the other and a specific angle. The sensor, connected to the electronic board, sends this information to it and it sends the command to the controllers of one and the other drive wheels (6), imposing a specific speed on each of them, so that the difference in speeds between them will generate the necessary turning of the scooter (1).

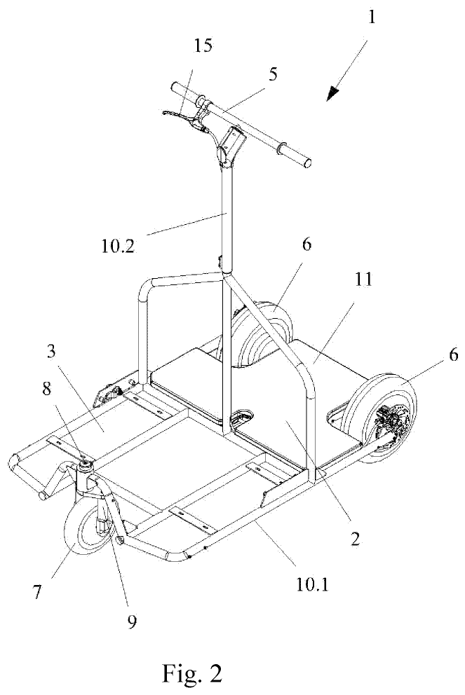

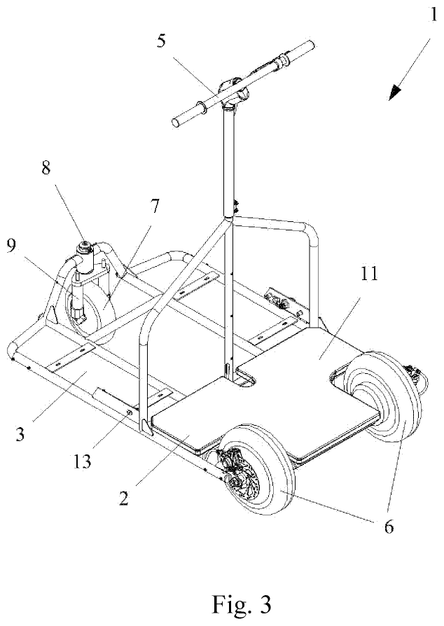

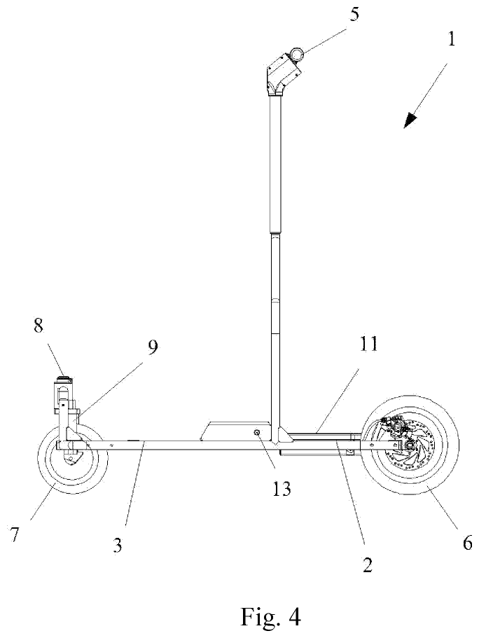

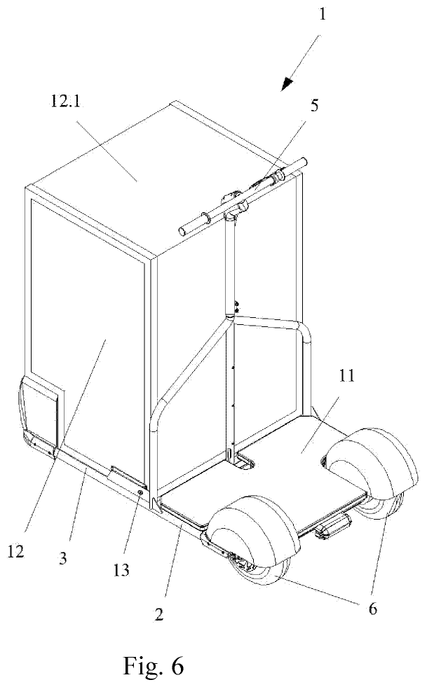

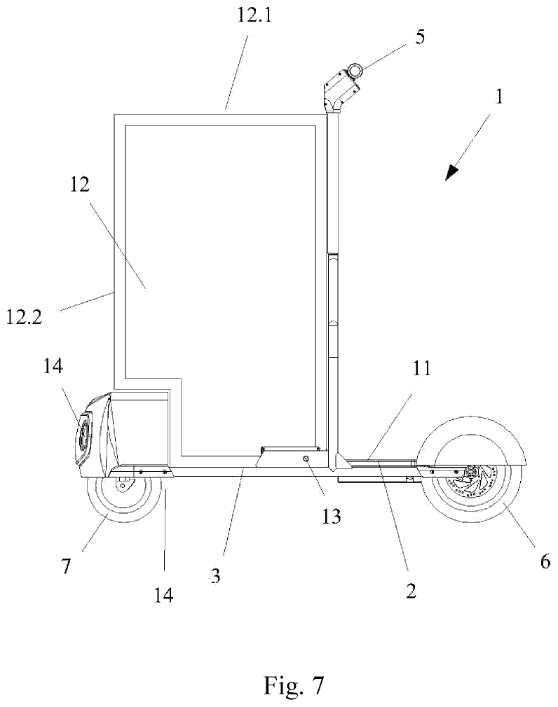

In this first preferred example of the invention, as shown in FIGS. 2 to 4 and 5 to 7, this scooter (1) has two driving wheels (6) located at one end of the chassis (4), which in this case corresponds to the rear of the scooter (1), and a support wheel (7) located at the opposite end to the first end of the chassis (4), i.e. in this case it is located at the front of the scooter (1).

However, in other examples, more than one support wheel (7) may be provided and the drive wheels (6) may be located at the front of the scooter (1) and the support wheel (7) at the rear of the scooter (1), as opposed to the example shown here.

As can be seen in FIGS. 2 to 4, this support wheel (7) is attached to the chassis (4) by means of a pivot shaft (8) with an upper end connected to said chassis (4) and a lower end connected to a suspension fork (9) attached to the axle of said support wheel (7). This connection mode allows free rotation of the support wheel (7) in any direction, 360°. This will allow the turning of the scooter (1) generated by the difference in speeds between the two driving wheels (6), in a comfortable and simple way.

The drive wheels (6) are fixed to the chassis (4) in a fixed position that only allows them to rotate around their axis.

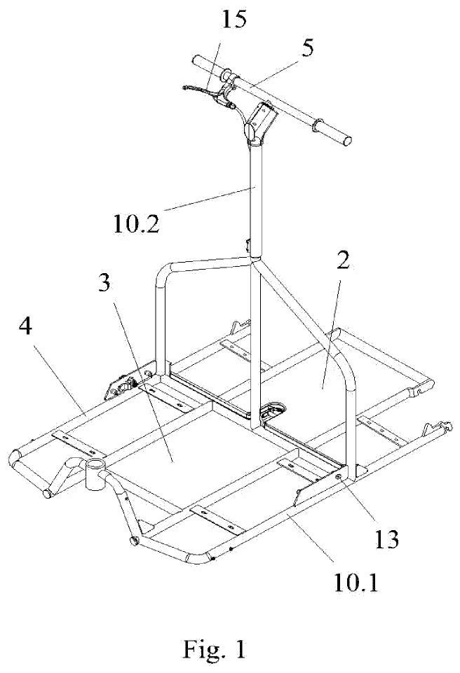

In another aspect, as shown in FIG. 1, in this first example, the load area (3) is located in a lower part (10.1) of the chassis (4), in a space between the support wheel (7) of the chassis and the driving wheels (6) of the chassis. In this first preferred example, the load area (3) is located at the front of the chassis (4), although in other examples it may be located at the rear of the chassis, but always within the space between the driving wheels (6) and the support wheel (7).

In this first preferred example of the invention, the electronic control sensor includes a potentiometer.

Likewise, in this first example, the device that drives the turning control system is formed by the handlebars (5) of the scooter (1). This handlebar (5) is connected to the potentiometer by means of a gear mechanism, so that when the handlebar (5) is turned as in any traditional scooter, the potentiometer detects the turning command and transmits it to the electronic board.

Therefore, the handlebar (5) does not have a mechanical functionality as in traditional scooters, as its rotation is not related to the rotation of the front wheel, which in this case is a support wheel, but serves as a drive for the electronic control sensor to generate the turning order.

In other preferred examples of the invention, the handlebar (5) is not movable and is fixed to the chassis. In this case, the device for operating the turning control may take the form of a control lever attached to the handlebar (5) itself and connected to the electronic control sensor. This allows the user to control the turning of the scooter by simple movements of the control lever.

In this preferred example of the invention, the electric motors connected to the two drive wheels (6) each have a wheel motor located next to the wheel. Thus, weight reduction and space utilisation are both achieved.

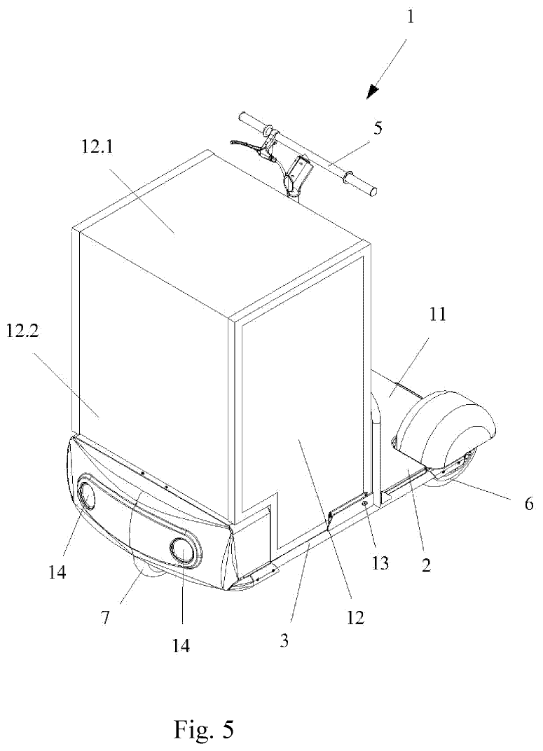

As shown in FIGS. 5 to 7, in this first preferred example of the invention, the load area (3) is provided with a load containment element (12) of such width and length that it can be fitted in the load area (3) and includes the means for attaching the load containment element (12) to the chassis (4). In this first example, fixing arrangements to the chassis (4) include a pin (13) fixed to the chassis (4) itself and accessible to the user.

In this first example, this containment element (12) is made up of a body forming a closed volume and includes means of access to its interior from at least one upper end (12.1) and/or one front face (12.2). Specifically, in this case, it includes means of access both at the front face (12.2) and at the upper end (12.1).

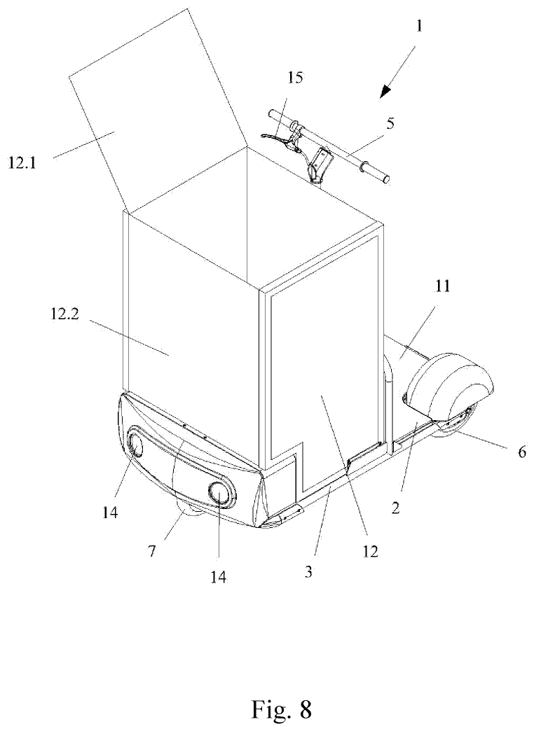

Access to the upper end (12.1) is provided by elements connecting the upper end (12.1) to the rest of the containment element (12), in this case hinged elements, such that the upper end (12.1) can be opened to one side of the containment element (12), as shown in FIG. 8. This prevents bumping into the handlebars (5) when opening the containment element (12).

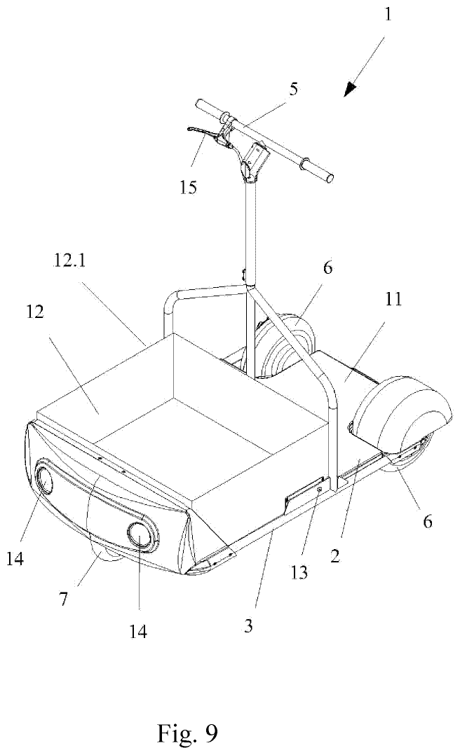

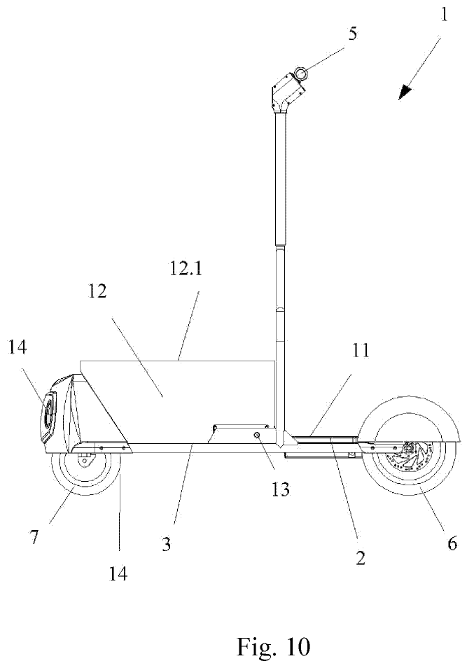

The containment element (12) may have other shapes and designs, such as the case of a second example shown in FIGS. 9 and 10, in which the containment element (12) consists of a body with an open upper end (12.1).

In the first preferred example of the invention, the electric scooter (1) has at least one rechargeable battery connected to the motor controllers, to the electronic board and in this case also to the lighting systems, where the battery is fixed to the chassis by means of removable fastening systems.

In this particular case, the scooter (1) includes a battery, so that when possible, the battery can be removed for recharging and replaced with a charged battery ready for operation.

In other examples, the scooter may feature two or more batteries connected in parallel, so that when one battery is depleted, a subsequent battery continues to power the circuit. Thus, a greater autonomy is achieved, so that the operation of the scooter (1) is not affected as it always has at least one more battery to continue operating until the depleted battery is replaced by a new one. Where possible, the battery can be removed for recharging and replaced with a charged battery ready for operation.

In this first preferred example of the invention, the scooter (1) includes a proximity sensor located on the front of the scooter (1). This increases safety, because if the sensor detects an obstacle, the scooter (1) reduces its speed or applies the emergency brakes.

As shown in FIG. 5, in this first preferred example of the invention, the scooter (1) includes at least one lighting unit (14) positioned at the front of the scooter, in this case two lighting units (14), in the form of headlights.

Furthermore, in this first preferred example, the scooter (1) includes disc brakes and electric brakes connected to the two driving wheels (6), as well as an operating mechanism (15) for these brakes attached to the handlebars (5).

Moreover, as shown in FIGS. 2, 3 and 6, in this first example, the foot rest area (2) is situated in the lower part (10.1) of the chassis (4) of the scooter (1), at the rear, and includes a support surface (11) with an anti-slip finish in the foot rest area (2).

As can be seen in FIG. 1, the chassis (4) of this scooter (1), in this first example, is made up of a series of tubular bars. Additionally, in this first example, the scooter (1) is fitted with wiring connecting the electrical elements and this wiring is attached to the lower part (10.1) of the chassis (4) below the support surface (11) and to a raised part (10.2) of the chassis (4) for supporting the handlebars (5), on the inside of the bars.

The described examples are merely intended as representative forms of this invention, therefore, the specific details, terms and phrases used herein are not to be regarded as limiting, but are to be understood only as a basis for the claims and as a representative basis for providing a comprehensive description and sufficient information for the person skilled in the trade to implement this invention.

1-17. (canceled)

18. An electric scooter (1) which includes a foot rest area (2) and a loading area (3) and is formed by a chassis (4) with a handlebar (5) fixed to the chassis (4), two driving wheels (6) at one end of the chassis, said electric scooter comprising:
two electric motors, each electric motor connected to a driving wheel (6) and to a motor controller, respectively. rotation control means comprising an electronic control sensor connected to a user-operated device and an electronic board being connected to said electronic control sensor and to the two motor controllers for controlling a speed of the driving wheels (6) so that a difference of speeds between the said driving wheels (6) allows a rotation of the electric scooter (1) and;
a support wheel (7) provided at a second end of a chassis (4) opposite to a first end where said driving wheels (6) are located, said support wheel (7) having a pivot shaft (8) with an upper end coupled to the chassis (4) and a lower end coupled to a suspension fork (9) attached to an axle of said support wheel (7).

19. The electric scooter according to claim 18, wherein the electronic control sensor includes a potentiometer.

20. The electric scooter according to claim 19, further comprising a handlebar (5) connected to said potentiometer through a gear mechanism to actuate said rotation control means.

21. The electric scooter according to claim 18, further comprising a handlebar (5) fixed relative to the chassis (2) and being fitted with a control lever which is attached to said handlebar (5) and connected to the electronic control sensor to actuate said rotation control means.

22. The electric scooter according to claim 18, wherein each electric motor includes a wheel motor.

23. The electric scooter according to claim 18, further comprising a loading area (3) located on a lower part (10.1) of the chassis (2) in a space between the support wheel (7) and the drive wheels (6).

24. The electric scooter according to claim 18, further comprising a loading area (3) including a load containment element (12) fitted in said loading area (3) and being fastened to the chassis (2).

25. The electric scooter according to claim 24, wherein said load containment element (12) is made up of a unit with an open upper end (12.1).

26. The electric scooter according to claim 24, wherein said load containment element (12) is formed by a unit having an enclosed volume that is accessed by at least one of an upper end (12.1) or a front face (12.2).

27. The electric scooter according to claim 24, wherein an enclosed volume of said load containment element (12) is accessed in at least one upper end (12.1) so that said at least one upper end (12.1) is opened towards one side of the load containment element (12).

28. The electric scooter according to claim 18, further comprising at least one rechargeable battery connected to at least said motor controllers and said electronic board, wherein said at least one rechargeable battery is removably fixed to the chassis (2).

29. The electric scooter according to claim 28, wherein said at least one rechargeable battery comprises at least two batteries connected in parallel.

30. The electric scooter according to claim 18, further comprising a proximity sensor located on the front of the scooter (1).

31. The electric scooter according to claim 18, further comprising at least one lighting unit (14) at the front of the scooter.

32. The electric scooter according to claim 18, further comprising a support surface (11) with an anti-slip finish in a user's foot rest area (2).

33. The electric scooter according to claim 18, wherein said chassis (4) is made up of a plurality of tubular bars.

34. The electric scooter according to claim 18, further comprising electrical wiring attached to a lower part (10.1) of the chassis (4) and below a support surface (11) of a user's foot rest area (2), wherein said electrical wiring is also provided inside tubular bars of said chassis (4).
